(19) United States
(12) Patent Application Publication
(10) Pub. No.: US 2024/0400060 A1
(43) Pub. Date: Dec. 5, 2024

(54) ASSISTIVE SYSTEM FOR VEHICLE PARAMETER SETUP

(71) Applicant: TOYOTA RESEARCH INSTITUTE, INC., LOS ALTOS, CA (US)

(72) Inventors: JOHN K. SUBOSITS, Mountain View, CA (US); Yun Jung Lee, Mountain View, CA (US); Shawn Manuel, Mountain View, CA (US); Avinash Balachandran, Sunnyvale, CA (US)

(73) Assignees: TOYOTA RESEARCH INSTITUTE, INC., LOS ALTOS, CA (US); TOYOTA JIDOSHA KABUSHIKI KAISHA, Toyota-Shi (JP)

(21) Appl. No.: 18/205,828

(22) Filed: Jun. 5, 2023

(51) Int. Cl. B60W 40/09; B60K 35/00; G07C 5/08

(52) U.S. Cl. CPC B60W 40/09; B60K 35/00; G07C 5/0808; B60K 35/10; B60K 35/22; B60K 2360/11; B60W 2050/0083

(57) ABSTRACT

Systems and methods are provided for optimizing vehicle setups through predictive determinations on subjective driver preferences. Examples provided herein include training a driver specific model based on first vehicle setups and subjective driver feedback of a driver on each first vehicle setup; applying the driver specific model on a second vehicle setup; generating, by the driver specific model, predicted subjective driver feedback on the second vehicle setup predictive of an opinion of the driver on the second vehicle setup; and selecting an optimal vehicle setup based on the predicted subjective driver feedback.

### TECHNICAL FIELD

The present disclosure relates generally to systems and methods configuring operating parameters of a race vehicle, and, more particularly, some embodiments relate to providing race vehicle setups through predicted determinations about driver subjective preferences.

### DESCRIPTION OF RELATED ART

A race engineer is an important member of a vehicle racing team. The race engineer works with team members, such as a driver, mechanics, and data engineers, to help the driver extract the best possible performance from a race vehicle for each race. One of the key duties of the race engineer is optimization of a vehicle setup for both the race track and the driver. A vehicle setup (e.g., engine operating parameters, handling/suspension parameters, etc.) comprises various parameters that define the operation of the race vehicle for the driver and a give race track. A typical race vehicle may be highly adjustable with a package of parameter settings, such as ride heights, wing angles, spring stiffnesses, damper settings, wheel alignment, tire pressure, among other settings that collectively define a vehicle setup.

The race engineer optimizes the setup of the vehicle in two ways. In one way, the race engineer may select an initial setup through review of historical data or high-fidelity simulation of vehicle setups that are correlated with performance of the vehicle for the race, such as lap time, time to completion, etc. The race engineer may then adjust the vehicle setup using data and driver feedback obtained through further simulation or from real-world driving during a race or during test days leading up or to a race.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method for optimizing a vehicle setup is provided. The method comprises training a driver specific model based on training data comprising a plurality of first vehicle setups and subjective driver feedback of a driver on each first vehicle setup of the plurality of first vehicle setups; applying the driver specific model on a second vehicle setup; generating, by the driver specific model, predicted subjective driver feedback on the second vehicle setup, wherein the predicted subjective driver feedback is predictive of an opinion of the driver on the second vehicle setup; and selecting an optimal vehicle setup for a vehicle based on the predicted subjective driver feedback.

In another aspect, a system for optimizing a vehicle setup is provided that comprises a memory storing instructions and one or more processors communicably coupled to the memory. The one or more processors are configured to execute the instructions to train a driver specific model based on training data comprising a plurality of first vehicle setups and subjective driver feedback of a driver on each first vehicle setup of the plurality of first vehicle setups; apply the driver specific model on a second vehicle setup; generate, by the driver specific model, predicted subjective driver feedback on the second vehicle setup, wherein the predicted subjective driver feedback is predictive of an opinion of the driver on the second vehicle setup; and select an optimal vehicle setup for a vehicle based on the predicted subjective driver feedback.

In another aspect, a vehicle setup selection system is provided that comprises at least one memory configured to store instructions and one or more processors communicably coupled to the at least one memory. The one or more processors are configured to execute the instructions to obtain candidate vehicle setup information comprising data on a plurality of candidate vehicle setups for configuring a race vehicle; generate subjective driver feedback for each of the plurality of candidate vehicle setups by applying the candidate vehicle setup information to a driver specific machine learning model trained on subjective data of a particular driver, wherein the generated subjective driver feedback is a prediction of a subjective opinion by the particular driver on each of the plurality of candidate vehicle setups; and provide a visualization of the plurality of candidate vehicle setups, the visualization comprising a graphical user interface (GUI) that displays each candidate vehicle setup and the subjective driver feedback for each candidate vehicle setup.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for assisting in optimizing a vehicle setup in accordance with one embodiment of the systems and methods described herein.

FIG. 3 is a schematic block diagram of an example operating environment for optimizing vehicle setup through predicted subjective feedback on subjective driver preferences in accordance with various embodiments disclosed herein.

FIG. 4 is a schematic representation of an example process flow for a vehicle setup recommendation system in accordance with embodiments disclosed herein.

FIG. 5 is a flowchart illustrating example operations that can be performed to optimize a vehicle setup in accordance with embodiments disclosed herein.

FIG. 6 is an example computing component that may be used to implement various features of embodiments described in the present disclosure.

The figures are not exhaustive and do not limit the present disclosure to the precise form disclosed.

### DETAILED DESCRIPTION

As described above, one of the key duties of a race engineer is optimization of a vehicle setup in view of both a race track on which the vehicle will be driven and the driver that will be driving the vehicle. An individual driver may have varying subjective opinions on performance of a vehicle for different vehicle setups. This subjective opinion may not only be specific to each vehicle setup, but may be unique between different drivers according to driver preferences for how a vehicle operates and feels while driving. The subjective preferences of a driver on which the subjective opinion is based cannot be easily or directly modeled through conventional simulation techniques.

Embodiments of the technology disclosed herein provide systems and methods configured to assist in optimizing vehicle setups through predictive determinations on subjective driver preferences. Namely, the embodiments disclosed herein are configured to predict determinations by generating predictive driver subjective feedback that is representative of a driver's subjective preferences. Embodiments disclosed herein provide for generating a machine-learning (ML) model that predicts subjective feedback about driver perceptions (e.g., opinions) of various vehicle setups. Embodiments disclosed herein ingest a plurality of vehicle operating parameters and apply the vehicle operating parameters to a trained machine-learning model, which outputs subjective determinations by generating subjective driver feedback on the individual vehicle parameters, which collectively define a vehicle setup. Predication of subjective driver feedback on a vehicle setup, as well as a parameter-by-parameter basis, can provide for customization of vehicle operating parameters in a way that is specific to driver preferences. The subjective preferences of the driver, as represented by the predicted subjective feedback, can then be balanced with objective performance metrics for optimization a real-world vehicle setup for the driver, a given race track, and race conditions.

Conventional systems are unable to predict subjective feedback about driver perceptions on vehicle setups and, as result, struggle to account for driver specific subjective preferences in selecting vehicle setups. Generally, a driver's subjective preference has been determined through a trial by error approach through real-world testing. That is, a vehicle would be configured with a vehicle setup and a driver would drive the vehicle around the track and then the driver would be asked a series of questions (e.g., provide a subjective opinion on the operation and/or feel of the vehicle. The vehicle setup would then be tweaked according to the subjective preference, and the process repeated. Another approach involves determining a drivability score for a race car and modeling a driver from the drivability score. In yet another approach, a historical driver was provided to a computer performed racing simulation and real-world, on-track racing performance could be predicted from the racing simulation. Another example approach allowed for simulation of different vehicle setups using different vehicle setup criteria and a simulator conveys how each vehicle setups can feel, drive, sound, and look to a driver, along with determining performance characteristics of a race. However, none of these approaches provided for predicting a particular driver's subjective opinion and/or feedback with respect to different vehicle setups that could then be used to optimize on-track setup testing.

The technology disclosed herein address the above-described short comings of the conventional system by modeling a driver's subjective preferences, which outputs subjective feedback. This subjective feedback can be used to aid in selection of vehicle setup for on-track testing and tuning of vehicle operating parameters. By predicting subjective determinations about a driver's perception of assorted vehicle setups, on-track testing and tuning can be optimized for efficiency and track lap time performance capability. Accurate prediction of subjective driver feedback allows embodiments disclosed herein to prescribe an initial on-track vehicle setup, as well as ranges of parameter adjustments that can maximize performance metrics and cater driving preferences of a particular driver.

Machine learning on a driver's preferences and feedback on a number of vehicle setups for varying track and/or race conditions allows for the prediction on subjective feedback to improve over time. Indeed, a practical result of the accurate prediction on subjective driver feedback to on-track testing can balance driving feel with objective performance metrics by customizing assorted vehicle operating parameters capable of adjustment. The prediction of a driver's perception of individual vehicle operating parameters, as well as the collective vehicle setup as a whole, can aid in generation of a racing strategy with a relatively high chance of success.

Race vehicle testing and tuning can be an iterative process that is refined over time. The temporally longitudinal nature can impact how vehicle setups are tweaked. For example, early in a race weekend and/or early in a race season an optimal strategy could be to try a high risk, high reward vehicle setup to generate useful data. An example of a high risk, high reward setup may be one that uses number of big changes to vehicle configuration that could lead to significant improvements in either or both of subjective and objective measures. Then as race weekend and/or end of the season draws closer, the vehicle setups may be tweaked with lower risk, lower reward. For example, a low-risk, low reward vehicle setup may involve small changes in one or more settings, particularly if the changes are easy to reverse. That is, for example, the overall the process can be one of big steps and broader search at first with fine-tuning at the end As another example, a high risk, high reward vehicle setup may be one that is more aggressive than the low risk, low reward setup, such as stiffer suspension, increased negative camber, etc.

The longitudinal nature, along with other relevant contextual factors, can be used to inform the machine learning during the training process. As such, embodiments disclosed herein may provide for iterative tuning of vehicle setups based on the longitudinal nature and other relevant contextual factors. For example, early in a race weekend or race season, an optimal strategy could be to try a high risk, high reward vehicle setup to generate useful data. Meanwhile, as the race or end of season approaches, increasing lower risk, lower reward vehicle setups may be used to fine tune adjustments more conservatively. Relevant contextual factors could include, but not limited to, weekend or season schedules, team standings both during a single weekend and throughout the season, beliefs and/or experience about the relative competitiveness of the vehicle on upcoming tracks on the schedule, rules around “Balance of Performance” (BOP) or “success ballast” adjustments/handicapping in a given racing series, and the like.

Accordingly, the technology disclosed herein provide technical improvements over conventional systems by minimizing, and potentially completely avoiding, a need to run explicit real-world simulations of vehicle setups on a track. Additional improvements are provided by correlating qualitative subjective determinations from drivers with actual, real-world quantitative solutions for adapting the vehicle. Conventionally, a vehicle would be configured according to a vehicle setup and the driver would then drive the vehicle around the track. Once completed the driver would be asked questions to elicit the driver's opinion of the vehicle set, e.g., “Did you like it?”; “Did you not like it?”; “Do you think it was stable?”; “Do you think you can make it through the corner really well?” “What do you think it was lacking or not?” Instead, the embodiments disclosed herein train driver model according to driver subjective feedback, which are based on a driver's subjective preferences. The trained model can then generate driver subjective feedback on input vehicle setups, which will provide model driven opinions on the above types of question. Using the generated opinion, vehicle setups can be tuned and re-applied to the trained model iteratively to output an optimal vehicle setup that is based on the driver's preferences. This optimal vehicle setup can then be used to configure a real-world vehicle for simulation and/or race day. Accordingly, the embodiments disclosed herein can optimize and automate the vehicle setup selection process in part by reduce the amount of time needed for this iterative process.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

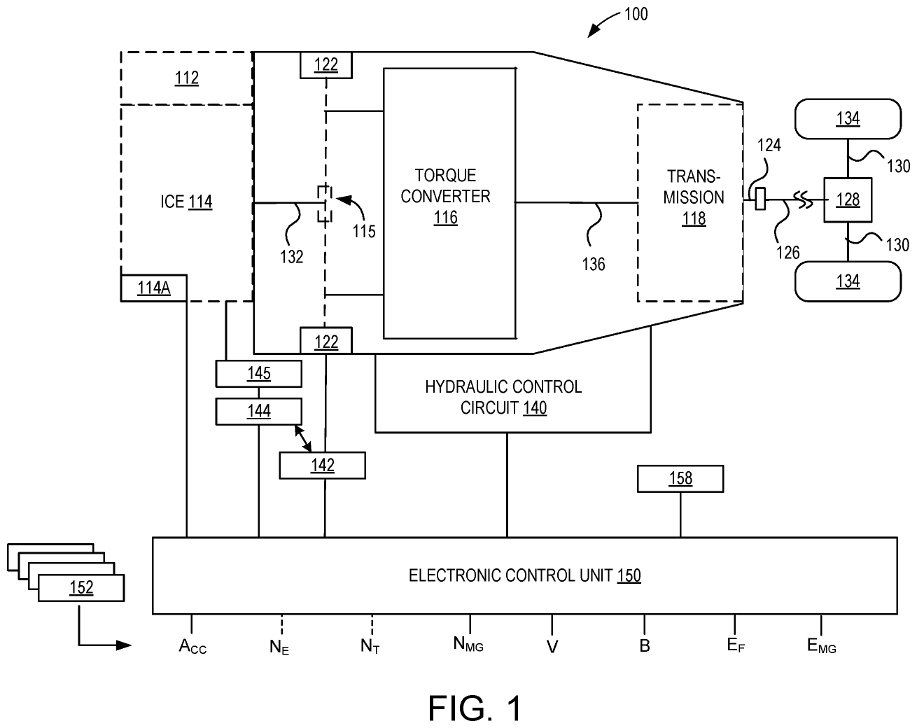

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. Various embodiments disclosed herein are particularly well situated for application in vehicular race environments, where the race vehicle is any vehicle or vehicle type. An example hybrid electric vehicle (HEV) in which embodiments of the disclosed technology may be implemented is illustrated in FIG. 1. Although the example described with reference to FIG. 1 is a hybrid type of vehicle, the systems and methods disclosed herein can be implemented using other types of vehicle including gasoline-or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount (A_{CC}), a revolution speed (N_{E}), of internal combustion engine 114 (engine RPM), a rotational speed (N_{MG}), of the motor 122 (motor rotational speed), and vehicle speed (V). These may also include torque converter 116 output (N_{T}) (e.g., output amps indicative of motor output), brake operation amount/pressure (B), battery SOC (i.e., the charged amount for battery 144 detected by an SOC sensor). Further vehicle operating conditions or characteristics can include yaw rate of the vehicle (r) (e.g., the angular velocity of the vehicle around its yaw axis), sideslip angle of the vehicle (β) (e.g. the angle between the direction the vehicle is pointing and the vehicle's linear velocity vector), lateral g-forces, etc. Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). In one embodiment, sensors 152 may be included to detect one or more conditions directly or indirectly such as, for example, fuel efficiency (E_{F}), motor efficiency (E_{MG}), hybrid (internal combustion engine 114+MG 122) efficiency, acceleration (A_{CC}), etc. Senors 152 may also be included to detect throttle position, steering angle, suspension position, brake pressure, gear, rotational acceleration, suspension loads, tire temperatures, brake temps, engine/propshaft torque, dynamic pressure (e.g., pitot tube), and so on.

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

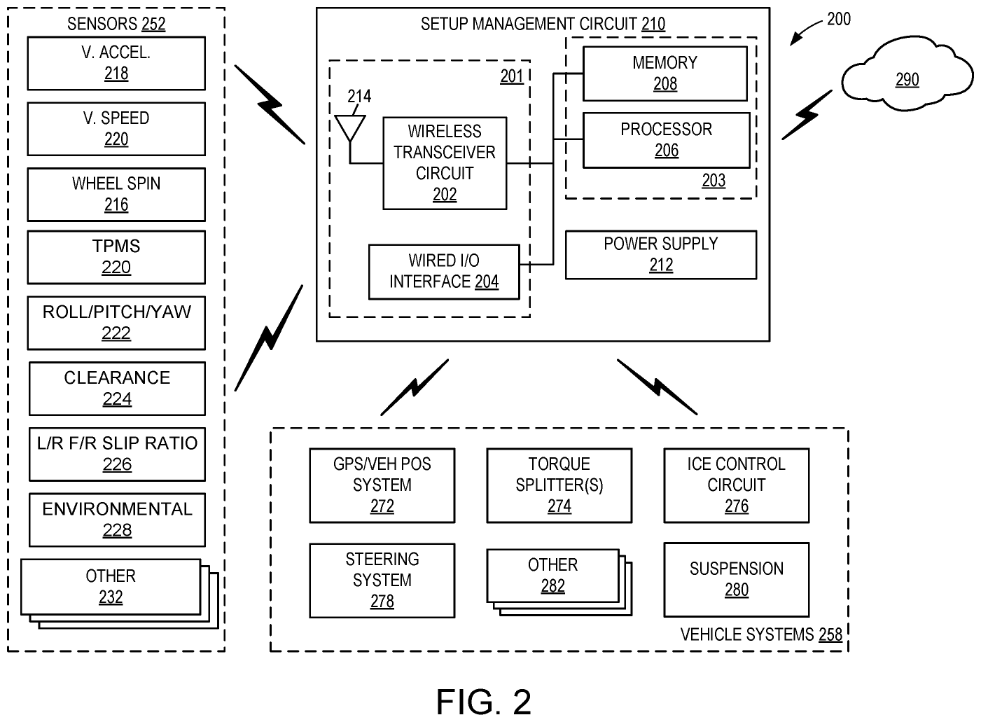

FIG. 2 illustrates an example architecture for assisting in optimizing a vehicle setup in accordance with one embodiment of the systems and methods described herein. Referring now to FIG. 2, in this example, vehicle setup system 200 includes a setup management circuit 210, a plurality of sensors 252 and a plurality of vehicle systems 258. Sensors 252 (such as sensors 152 described in connection with FIG. 1) and vehicle systems 258 (such as subsystems 158 described in connection with FIG. 1) can communicate with setup management circuit 210 via a wired or wireless communication interface. Although sensors 252 and vehicle systems 258 are depicted as communicating with setup management circuit 210, they can also communicate with each other as well as with other vehicle systems. setup management circuit 210 can be implemented as an ECU or as part of an ECU such as, for example electronic control unit 150. In other embodiments, setup management circuit 210 can be implemented independently of the ECU.

Setup management circuit 210 in this example includes a communication circuit 201, a decision circuit 203 (including a processor 206 and memory 208 in this example) and a power supply 212. Components of setup management circuit 210 are illustrated as communicating with each other via a data bus, although other communication interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as vehicle setup information including vehicle operating parameters and vehicle states. Memory 208 can be made up of one or more modules of one or more different types of memory, and may be configured to store data and other information as well as operational instructions that may be used by the processor 206 to setup management circuit 210. As will be described below, vehicle operating conditions or characteristics of vehicle 100 may be stored in memory 208. Accordingly, this stored information may optionally be used to for training a driver model.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a setup management circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing setup management circuit 210 to communicate with edge devices, such as roadside unit/equipment (RSU/RSE), computing systems, and cloud servers and cloud-based databases via network 290. For example, V2X communication capabilities allows setup management circuit 210 to communicate with edge/cloud servers, roadside infrastructure (e.g., such as roadside equipment/roadside unit, which may be a vehicle-to-infrastructure (V2I) enabled trackside equipment), etc.

As this example illustrates, communications with setup management circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by setup management circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or not otherwise be included on a standard vehicle 100 with which vehicle setup system 200 is implemented. In the illustrated example, sensors 252 include vehicle acceleration sensors 218, vehicle speed sensors 220, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of vehicle setup system 200. For example, there may be additional sensors for detecting and/or computing sideslip velocities, sideslip angles, percent sideslip, frictional forces, degree of steer, heading, and trajectory. Additionally, there may be sensors for detecting and/or computing front tire slip angle corresponding to full tire saturation, rear tire slip angle corresponding to full tire saturation, maximum stable steering angle given speed/friction, coefficient of friction between vehicle 100 tires and roadway, etc. As alluded to above, there may also be sensors for total lateral force, rear lateral force, front lateral force, longitudinal speed, lateral speed, longitudinal acceleration, brake engagement, steering wheel position, time derivatives of steering wheel position, throttle, time derivatives of throttle, suspension position, brake pressure, gear, rotational acceleration, suspension loads, tire temperatures, brake temps, engine/propshaft torque, dynamic pressure (pitot tube), and etc.

Additional sensors 232 may also include sensors which obtain information related to the contextual environment in which vehicle 100 is operating. For example, as alluded to above, additional sensors 232 may include imaging sensors (such as cameras), and proximity sensors (such as radar, lidar, and sonar) which may be used to detect the movement and location objects, such as vehicles and pedestrians. For example, these imaging and proximity sensors may detect and compute the speed, acceleration, heading, and location of other vehicles and pedestrians. These sensors may also detect the operation of phase of track lights (e.g., green, yellow, red), road curvature, road grade, obstacles, and so on.

Vehicle systems 258 can include any of a number of different vehicle components or subsystems used to control or monitor various aspects of the vehicle and its performance. For example, vehicle systems 258 may configure the vehicle according to a vehicle setup. One or more vehicle systems 258 may function to adjust and/or tune vehicle components according to vehicle operating parameters defined in the vehicle setup. In this example, the vehicle systems 258 include a GPS or other vehicle positioning system 272; torque splitters 274 that can control distribution of power among the wheels such as, for example, by controlling front/rear and left/right torque split; engine control circuits 276 to control the operation of the engine (e.g., internal combustion engine 14); steering system 278 (which may be the steering by-wire system described in conjunction with FIG. 1) to turn the wheels of vehicle 100; suspension system 280 such as, for example, an adjustable-height air suspension system, an adjustable camber system, adjustable suspension stiffness system, and the like, and other vehicle systems 282, such as aerodynamic adjustment systems (e.g., systems for automated adjustment of wing and splitter angles and ride height Front/Rear). Vehicle systems 258 may also include the brake-by-wire system described in conjunction with FIG. 1.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 290 may include one or more IEEE 802.11 wireless networks.

During operation, setup management circuit 210 can receive information from various vehicle sensors, which can be stored in memory 208 and/or communicated to remote systems using communication circuit 201 over network 290. Communication circuit 201 can be used to transmit and receive information between setup management circuit 210 and sensors 252, and setup management circuit 210 and vehicle systems 258. Also, sensors 252 may communicate with vehicle systems 258 directly or indirectly (e.g., via communication circuit 201 or otherwise).

In various embodiments, communication circuit 201 can be configured to receive data and other information from sensors 252 which setup management circuit 210 may use to define a vehicle setup and/or determine vehicle states. Additionally, communication circuit 201 can be used to send information for use in training a driver model and/or evaluating performance of a vehicle setup according to predicted subjective feedback. For example, communication circuit 201 can be used to send signals to, for example, a remote backend system over network 290. The backend system, as described in greater detail below, may be configured to generate a driver model by applying subjective driver feedback, vehicle setup information, and, optionally, time series data from sensors 252 of setup management circuit 210 to a driver machine-learning algorithm. The subjective driver feedback, vehicle setup information, and optional, time series data may be used as training data for training a driver model on a vehicle setup as defined by the vehicle setup information. In another example, the backend system, as described in greater detail below, may also be configured to use time series data along with objective performance metrics of a race to balance a cost function that optimizes tradeoffs between driver subjective determinations predicted by applying a vehicle setup to a trained driver model and objective performance. The backend system can then suggest an optimal vehicle setup for vehicle 100 that balances the objective performance metrics with the driver's subjective preferences. The optimal vehicle setup can then be communicated to setup management circuit 210 through network 290, and setup management circuit 210 can use communication circuit 201 to send a control signal or other control information to various vehicle systems 258 as part of configuring the vehicle 100 according to the vehicle setup. In another example, alone or in combination with the preceding example, the vehicle setup can be provided to a mechanic, who can then configure the vehicle 100 according to the vehicle setup.

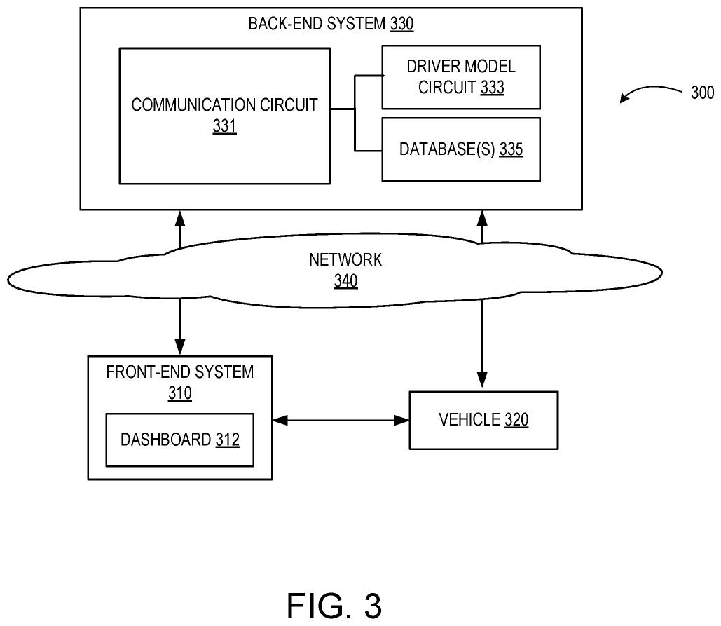

FIG. 3 is a schematic block diagram of an example operating environment 300 for optimizing vehicle setup through predicted subjective feedback on subjective driver preferences in accordance with various embodiments disclosed herein. The environment 300 includes a front-end system 310, a vehicle 320, and backend system 330. The vehicle 320 may be implemented as vehicle 100 having vehicle setup system 200 installed therein. These elements of the environment 300 may be communicatively coupled to network 340, which may be an example of network 290 of FIG. 2.

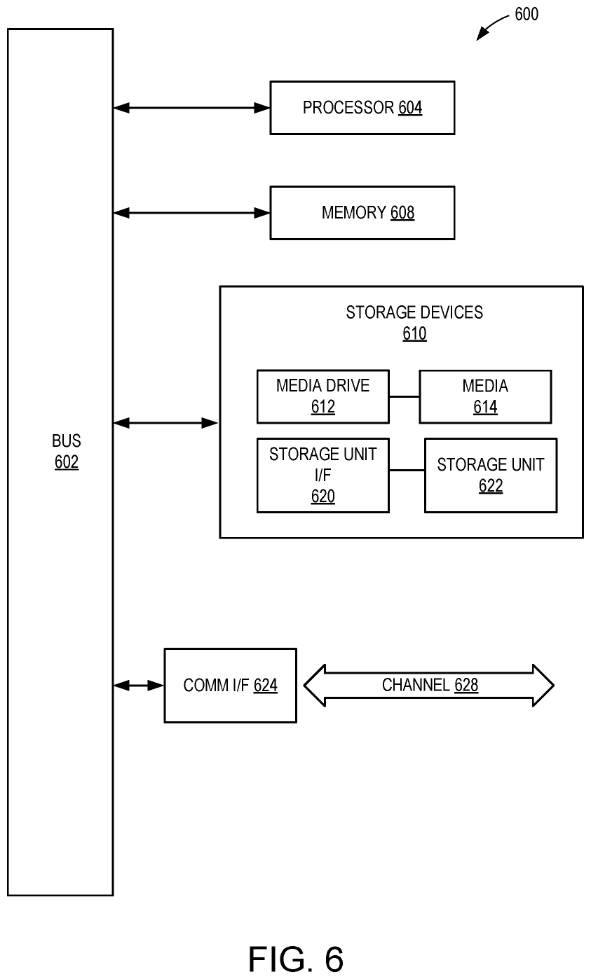

The back-end system 330 in this example includes a communication circuit 331, a driver model circuit 333 (including a processor coupled to a memory). Components of back-end system 330 are illustrated as communicating with each other via a data bus, although other communication interfaces can be included. The communication circuit 331 may be similar to communication circuit 201 of FIG. 2. The back-end system 330 may be implemented as a local server and database(s), a cloud or edge server coupled to cloud-based database(s) resident on network 340, or any computing device, such as computing component 600 of FIG. 6.

The processing units of driver model circuit 333 may execute instructions stored in memory to execute and control functions of the back-end system 330. The back-end system 330 implement a driver model system that executes a plurality of phases: a data collection phase, a training phase, and a testing/run-time phase.

In the data collection phase, training data is obtained from various data sources. For example, training information may include information defining one or more vehicle setups (referred to herein as vehicle setup information). A vehicle setup refers to a collection of physical, mechanical, and/or electronic operating parameters that determine how a vehicles will behave while driving. Vehicle setup information can be provided as the vehicle operating parameters that collectively define a configuration for a vehicle, such as, but not limited to, engine operating parameters, handling/suspension parameters, aerodynamic setting parameters, etc. These vehicle setup parameters may be varied from one vehicle setup to the next. In an illustrative example, a first vehicle setup may include vehicle operating parameters, such as, Group Grand Touring (GT) 3, front shock to 800 N/mm, rear camber at −1.5 degrees, among others. A second vehicle setup may include the same parameters except rear camber set to −1 degree. Numerous vehicle setups are possible. The vehicle setup information can be input, for example, into front-end system 310 by an end-user (e.g., a race engineer or other team member) and communicated to back-end system 330 via network 340 for storage in database(s) 335.

Training data may also include driver subjective feedback on vehicle setups contained in the training data. For example, a driver may operate vehicle 100 (e.g., drive the vehicle around a race track) configured according to each vehicle setup and then provide subjective feedback on the vehicle's operation and feel in performing maneuvers while driving the vehicle. In an illustrative example, the driver may complete a questionnaire by entering subjective opinions on a number of vehicle states listed on the questionnaire. In another example, subjective opinion could be supplied by verbal interviews of natural language processing on spoken opinions. The driver's subjective opinion could be provided as evaluation scores assigned to each vehicle state. In one example, driver's opinion may be provided in binary responses (e.g., Yes/No or Like/Dislike) for each vehicle state, and each binary response can be converted to a evaluation score on a binary scale (e.g., 1 or 0 or other binary weighting as desired for a given application). The evaluation scores can then be provided to the back-end system 330 as subjective driver feedback information. In another example, the driver's opinion may be provided by assigning an evaluation scores to each state on a linear scale (e.g., assign a score to each state on a linear scale of 0 to 10, 10 being perfect and 0 being the worst, or 0 to 5, or any linear scale desired). The assigned scores and associated maneuvers (or an identifier therefor) are then provided to the back-end system 330 as subjective driver feedback information. Example states include, but are not limited to, stability, corner entry, middle of corner, exiting corner, 2-4 in low speed vs high speed (e.g., defining a state for corner entry, middle, and exit for high and low speeds respectively), etc. The driver subjective feedback information can be input, for example, into front-end system 310 and communicated to back-end system 330 via network 340 for storage in database(s) 335.

In yet another example, the driver could be connected to psychophysiological feedback devices, such as, but not limited to, skin conductance (SC), Electroencephalography (EEG) and Electrocardiogramat detect the psychophysiological states (e.g., stress levels, anxiety levels, etc.) as time series data of the driver while driving the vehicle. The psychophysiological states can be correlated to vehicle states and processed to generate a driver opinion, where the psychophysiological states can be converted to an evaluation score on either the binary or linear scale based on a relative magnitude of the detected psychophysiological state relative to a baseline. Then, similar to the above, the evaluation scores and associated vehicle states can be communicated to back-end system 330 as subjective feedback information.

In some embodiments, training data may include vehicle states received as time series data. The time series data for each vehicle setup may be obtained from vehicle 320 (e.g., from sensors 252 and/or vehicle systems 258) during real-world operation by the driver, and/or from computer simulation of each vehicle setup and communicated to back-end system 330 from front-end system 310. In either case, the time series data may be stored in database(s) 335.

A vehicle state may comprise data associated with one or more operational state variables of a vehicle. For example, vehicle state may comprise data associated with operational state variables such as vehicle speed, vehicle acceleration, heading, and trajectory. Vehicle state may include other operational state variables such as lateral force, yaw rate, sideslip angle, heading error with respect to a reference trajectory, lateral bound error with respect to a reference trajectory, stability, corner entry, middle of corner, exiting corner, 2-4 in low speed vs high speed, etc. The vehicle state may be time series data comprised of a current or measured vehicle state for a time horizon. In some embodiments, the vehicles states data may be obtained from sensors 252 and/or vehicle systems 258.

In the training phase, a driver ML algorithm is applied to the training data to generate a driver model for each driver. For example, training data can be divided into subsets corresponding to each unique driver. The driver ML algorithm is then applied to each subset of training data corresponding to a respective driver to generate a driver specific model for the respective driver. ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. Other example ML algorithms include, but are not limited to, regression techniques, such as, multi-layer perceptron (e.g., neural network), support vector regression, generalized linear model, and regression trees/random forests, Bayesian optimization (e.g., Bayesian multivariate adaptive regression splines (BMARS), Bayesian additive regression trees (BART), etc.). The ML algorithms disclosed herein may be supervised and/or unsupervised depending on the implementation.

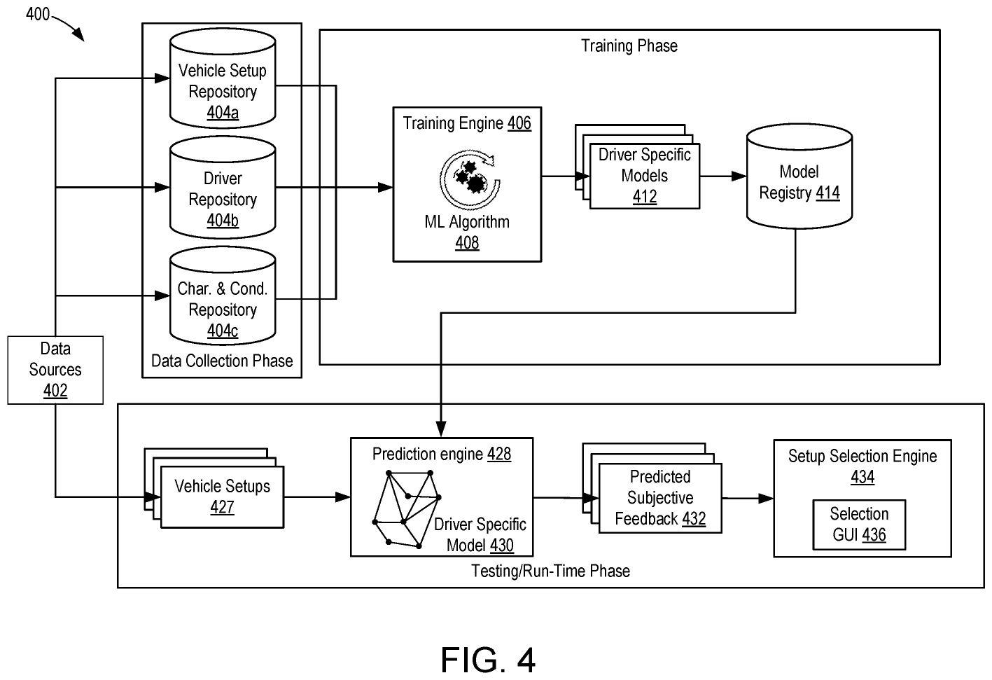

In an illustrative example, the driver ML models can be trained according to training parameters, which may be used to constrain the training. Training parameters may be set according to relevant contextual factors, such weekend or season schedules, team standings both during a single weekend and throughout the season, and the like. The training parameters, through training of the ML model (for example, as described below in connection below FIG. 4), may account for the temporal longitudinal nature of vehicle tuning, such that high risk, high reward vehicle setups can be recommended early on and low risk, low reward setups recommended as race day (or season end) approaches. That is, for example, more deference may be given to a driver's subjective preferences early on over objective performance, or vice versa, to provide high risk, high reward. As another example, larger or more aggressive tuning of vehicle operating parameters can be recommended early on, and smaller tweaks recommended as a race approaches.

In the testing/run-time phase, test vehicle setup information defining candidate vehicle setups can be input into a trained driver specific ML model, which generates a prediction of subjective driver feedback for each candidate vehicle setup. As described above, each driver specific ML model corresponds to a distinct driver and the generated subjective feedback is specific to the driver (e.g., true and dependent on the respective driver). In one example, the generated feedback may be provided as a predicted evaluation score for the candidate vehicle setup as a whole. In another example, the generated feedback may be provided as predicted evaluation scores for vehicle operating parameter that make up the candidate vehicle setup. The evaluation scores may be provided on a binary scale or a linear scale, as described above.

The generated subjective score can then be used by back-end system 330 to determine an optimal vehicle setup, which can be communicated to the front-end system 310 and used to configure the real-world vehicle according to the setup. In one example, the optimal vehicle setup may be dependent on the predicted subjective feedback alone. In another example, the optimal vehicle setup may be based on a tradeoff between objective performance metrics and the driver's subjective preferences as characterized by the predicted subjective feedback. Examples of objective performance metrics include, but are not limited to, lap times around a track, total race time, pit stop frequency, tire wear, fuel consumption rate, distance between vehicle race line (e.g., path traveled by the vehicle) and ideal race line, among others. Each objective performance metrics can be obtained through real-world operation of a vehicle configured according to a vehicle setup and/or through computer simulation on a vehicle setup. In certain cases, there may exist a tradeoff between the objective performance of a vehicle and the subjective preferences of the driver (e.g., a vehicle setup preferred by a driver may not translate to an ideal simulated performance). However, it may be desirable to meet the driver's preferences as a comfortable and subjectively satisfied driver may be able to drive the vehicle faster and more aggressively as compared to a case where the preferences are not met. For example, the most preferred setup for the driver may not always be the fastest in simulation. Yet I the preferred setup may actually be the fastest in real-world execution because the vehicle setup that makes the driver sufficiently comfortable allows the driver to drive their best. Thus, back-end system 330 may balance the objective performance metrics with predicted subjective feedback to determine an optimal vehicle setup.

An end-user, such as a race engineer in various examples, may interface with the back-end system 330 using the front-end system 310, which may provide access via a dashboard 312 or other graphical user interface (GUI) generated on the front-end system 310. The front-end system 310 may be provided as one or more of a mobile device, a personal computer, a laptop, a tablet, and any computing device, such as computing component 600 of FIG. 6. The dashboard 312 may be hosted by the back-end system 330 accessed via a web portal or hosted locally on the front-end system 310. End-users may enter inputs via dashboard 312, which back-end system 330 may receive from front-end system 310, and back-end system 330 may sent information to front-end system 310 for presentation via the dashboard 312 or applicable GUI.

While the foregoing description is provided with reference to back-end system 330 executing the plurality of phases, embodiments disclosed herein are not intended to be limited to this implementation. Execution of one or more phases may be performed on the front-end system 310, or distributed between the back-end system 330 and front-end system 310. For example, back-end system 330 may be implemented to execute the data collection and training phases to generate driver specific ML models and one or more driver specific ML models may be deployed onto front-end system 310 for application to candidate vehicle states in the testing/run-time phase. In another example, front-end system 310 may be perform all of the phases.

As alluded to above, recommending an optimal vehicle setup can be accomplished over the course of a collection phase, a training phase, and a testing/run-time phase. FIG. 4 is a schematic representation of an example process flow for a vehicle setup selection system 400 embodying these phases separated into training phase and run-time phase. System 400 may be implemented, for example, by back-end system 330 and/or front-end system 310 of FIG. 3.

Vehicle setup selection system 400 is configured to assist a race engineer in selecting an optimal vehicle setup. This setup may be an initial vehicle setup or a later progressive setup determined through iteration of vehicle tuning. Vehicle setup selection system 400 functions to predict driver subjective feedback on one or more candidate vehicle setups based on similarity to other vehicle setups, as well as on data of objective performance metrics of the vehicle setup on track through real-world testing or simulation. For different combinations of vehicle parameters, where each combination collectively defines a vehicle setup, a driver may have different subjective feedback about the operation and/or feel of the vehicle that isn't directly modeled through standard simulation. For example, the driver may indicate that a vehicle configured according to a vehicle setup is unstable under braking. Vehicle setup selection system 400 trains driver specific models so to predict these responses for distinct drivers and provide suggestions for adapting vehicle setups or a range of suggestions for simulation to guide further selection.

As shown in FIG. 4, during the data collection phase, data sources 402 commit training data to databases 404a-404c, which can be used by vehicle setup selection system 400 to build sets of training data on a driver-by-driver basis. Repositories 404a-404c may be implemented as database(s) 335 of FIG. 3. Data sources 402 may include, for example, front-end system 310 and/or vehicle 320 as described above in connection with FIG. 3. For example, sets of vehicle operating parameters (e.g., combinations of vehicle operating parameters) may be input into front-end system 310, each set may define a training vehicle setup. Front-end system 310 may then commit the vehicle setups to vehicle setup repository 404a as vehicle setup information.

Also during the collection phase, driver subjective feedback information may be input into front-end system 310 for each vehicle setup. As described above, the driver subjective feedback can be derived from subjective evaluations scores assigned to vehicle states according to each vehicle setup. Front-end system 310 may then commit the driver subjective feedback information to driver repository 404b. Each driver may provide unique feedback for each vehicle setup. As a result, driver feedback information may be arranged according to each driver, and further arranged according to vehicle setup. That is, a driver identifier may be associated with all driver feedback data for a given drive, and a vehicle setup identifier associated with driver feedback data corresponding to the respective vehicle setup.

In some embodiments, vehicle operating characteristics and conditions data may be obtained as time series data, for example, from a vehicle (e.g., from sensors 252 and/or vehicle systems 258) or from simulation of a vehicle setup. In the case of a real-world test, the vehicle may commit the time series data to state repository 404c, while in the case of a simulation, front-end system 310 may commit the data to repository 404c. The time series data may be processed to project the time series data into a lower dimension space. For example, the time series data may contain a number of data types or dimensions (e.g., vehicle speed, heading, pedal angle, etc.). The number of dimensions can be reduced by projecting the time series data to a lower dimensionality.

The projection to a lower dimension space can be achieved through dimensionality reduction techniques, such as but not limited to, an autoencoder, a neural network, or the like. For example, end-to-end training may leveraged using a low dimensional “latent space” to predict the driver's subjective scores. In this case, the dimensionality reduction and use of the latent space could be used concurrently. The input data could be the raw time series data in one example. In another example, the input could be other representations, such as, but not limited to, tuples of vehicle states, driver action, and new vehicle state.

During the training phase, training data for a driver is obtained by training engine 406 from at least repositories 404a and 404b (and optionally from 404c). The training data is applied to a driver specific ML algorithm 408 to generate a driver specific ML model 410 trained on the training data. For example, evaluation scores provided by the driver for each vehicle setup are converted to weights that are assigned to each corresponding vehicle setup, so to train the driver specific ML algorithm 408 on the subjective preferences of the driver (e.g. higher weight means driver preferred the vehicle setup as indicated by the evaluation score). In another example, each vehicle state may be attributed a weighted according to the assigned evaluation score for that vehicle state, and a summation, average, etc. of weights of vehicle states for a given vehicle setup may be assigned to the vehicle setup as a total weight. The driver specific ML algorithm 408 can then be trained on the weighted vehicle setups. The training process is specific to the ML algorithm 408 implemented. For example, network nonlinear optimization (e.g., backpropagation) may be used in the case of a neural network, while adjustment of kernel parameters can be used in the case of a Gaussian process. Other training techniques are possible dependent on the algorithm implemented. The driver ML algorithm 408 may be supervised and/or unsupervised depending on the implementation. The driver specific ML model 410 is then stored in model registry 414, such as a database(s) 335 of FIG. 3.

Further, in some embodiments, an impact of vehicle parameters to assigned evaluation scores can be analyzed by sensitivity analysis techniques. For example, for a given vehicle setup, the impact of each parameters that makes up the vehicle setup can be calculated as a sensitivity measure indicative of the impact of a particular vehicle parameter to the evaluation scores. Some possible sensitivity analysis techniques include, but are not limited to, One-Factor-At-A-Time method, derivative-based local methods, regression analysis, variance-based methods, variogram analysis of response surfaces (VARS), screening, scatter plots, and the like.

The training phase may be repeated for a number of drivers to generate a plurality of driver specific ML models 412 stored to model registry 414. For example, training data corresponding to a first driver may be applied the ML algorithm 408 to generate a first driver specific ML model, and training data corresponding to a second driver may be applied the ML algorithm 408 to generate a second driver specific ML model. In this way, a plurality of driver specific ML models 412 can be created for a plurality of drivers, which can be used to predict each driver's subjective preferences.

During the run-time phase, a prediction engine 428 can be deployed on a run-time machine. For example, prediction engine 428 may be deployed in a front-end system 310 of FIG. 3 as an example run-time machine. In another example, prediction engine 428 may be deployed in back-end system 330 of FIG. 3, as another example run-time machine, and accessed through dashboard 312. In either case, prediction engine 428 comprises one or more driver specific ML models 430, reflecting one or more models 412 to be ran in the run-time phase. For example, a data source 402 may select one or more drivers, for example, by an end-user inputting driver identifies into a front-end system 310. One or more driver ML models plurality of driver ML models 412 can then be retrieved from model registry 414 according to the selected drivers and deployed in prediction engine 428.

Once the one or more driver ML models 430 are deployed (e.g., operationalized), prediction engine 428 can accept one or more candidate vehicle setups 427 provided by data sources 402 to generate predicted subjective feedback 432 on each candidate vehicle setup 427. That is, as a result of the training of the driver specific ML models 430, each of the one or more driver specific ML model 430 deployed in prediction engine 428 generates subjective driver feedback 432 predictive of a corresponding driver's subjective opinion on each candidate vehicle setup 427. For example, a prediction engine 428 accepts a candidate vehicle setup 427 as a collection of vehicle parameters and applies the candidate vehicle setup 427 the driver specific ML model 430, which generates predictive subjective driver feedback 432 corresponding to the driver on which a respective driver ML model 430 was trained. In the case of multiple candidate vehicle setups, prediction engine 428 may apply each candidate vehicle setup to driver specific ML model 430 to generate feedback reflective of the driver's opinion on each candidate vehicle setup. The multiple candidate vehicle setups may be executed in parallel or a sequential manner, for example, an initial setup ran first and another after the initial that accounts for the opinion on the initial setup.

Predicted subjective feedback 432 may be provided as a predicted evaluation score for each candidate vehicle setup 427. In one example, prediction engine 428 may apply a candidate vehicle setup 427 to a driver specific ML model 430 as vehicle setup information. The driver specific ML model 430 takes the vehicle setup information and predicts one or more evaluation scores according to the driver's preference per the training used to generate the driver specific ML model 430.

In one example, the driver specific ML model 430 generates a single evaluation score for the candidate vehicle setup 427 as a whole, which may be provided in binary or linear scale. The prediction engine 428 takes this prediction and outputs a predicted subjective feedback 432 containing the evaluation score and vehicle setup.

In another example, the driver specific ML model 430 generates a plurality of evaluation scores for the candidate vehicle setup 427, which may be provided in binary or linear scale. In this case, driver specific ML model 430 generate a list of vehicle states (e.g., similar to the vehicle states used to generate training subjective feedback). Driver specific ML model 430 may then analyze the vehicle operating parameters that make up the candidate vehicle setup 427 and, based on the training, generate an evaluation score—on either a binary or linear scale—for each vehicle state. The prediction engine 428 takes these predictions and outputs a predicted subjective feedback 432 containing the predicted evaluation scores assigned to the vehicle states. In some implementations, an aggregate of the predicted evaluation scores can be used as a single score for the vehicle setup. IN this case, prediction engine 428 may output predicted evaluation scores assigned to the vehicle states, the aggregate evaluation score assigned to the vehicle setup, or both.

The above describe functionality of prediction engine 428 can be performed on each candidate vehicle setup 427. Prediction engine 428 can then operate to provide one or more predicted subjective feedbacks 432, each corresponding to a candidate vehicle setup 427.

Predicted subjective feedback 432 or a number thereof can be provided to a vehicle setup selection engine 434 that outputs vehicle setup recommendations to the run-time machines based on the predicted subjective feedback 432. For example, vehicle setup selection engine 434 may output all candidate vehicle setup 427 and corresponding evaluation scores for review and selection therefrom. In another example, vehicle setup selection engine 434 may select a highest rated (e.g., highest evaluation score) predicted subjective feedback 432 and present the selected predicted subjective feedback 432. In yet another example, a threshold evaluation score may be set such that predicted subjective feedback 432 outputs only those candidate vehicle setup 427 that have predicted evaluation scores equal to or greater than the threshold. The threshold evaluation score may be set on vehicle setup basis and/or a vehicle state basis.

Vehicle setup selection engine 434 may be configured to generate a visualization of the candidate vehicle setups 427 for visual review and selection by end-users. The visualization can include a selection GUI 436 that can provide a visual representation of each candidate vehicle setup and corresponding predicted subjective opinions for each of the candidate vehicle setup. The selection GUI 436 may be provided to allow end-users to visually review candidate vehicle setups and corresponding predicted subjective opinions for each of the candidate vehicle setups. GUI 436 may be presented via dashboard 312 in some examples.

In some implementations, the prediction engine 428 can determine an impact of each vehicle parameter on the predicted subjective feedback 432, which be provided as sensitivity measures of impact on each parameter. Sensitivity measures can be calculated using sensitivity analysis techniques as described above. The sensitivity measure may be provided in any format desired, such as, but not limited to, a partial derivative, change in output relative to change in input, and the like. In some examples, the sensitivity measure can be provided in physical units (e.g., Δ(subjective score)/Δ(wing angle in deg) in an example case where the adjusted parameter is a wing angle) or in nondimensional (e.g., Δ(subjective score)/Δ(wing angle as percent of adjustment range)). The sensitivity measures provide a quantitative means for comparing how sensitive a given vehicle operating parameter has on the predicted subjective feedback 432 (e.g., the impact a vehicle operating parameter has the predicted subjective feedback 432). The most impactful vehicle operating parameter may be the parameter having the largest sensitivity measure and the least impactful parameter has the smallest sensitivity measure. The sensitivity measures may be presented on GUI 436 in association with each corresponding vehicle operating parameter for use in evaluating a vehicle setup. Further, the end-user may be able to identify which vehicle operating parameters can be tuned without significantly altering the predicted subjective feedback 432 in a negative direction, or which parameters can be tuned to improve the predicted subjective feedback 432.

In some implementations, vehicle setup selection engine 434 output vehicle setup recommendations based on a balancing of the predicted subjective feedback 432 against objective performance metrics. For example, vehicle setup selection engine 434 may perform the balancing through sequential optimization by optimizing a function:

$${\sum }_{i} {w}_{objective , i} {J}_{objective , i} ( x ) + {\sum }_{j} {w}_{subjective , j} {J}_{subjective , j} ( x ) = {J}_{Optimized} ( x ) \qquad Eq . 1$$

where J_{objective,j} represents vector of obtained by collecting or concatenating a number of j objective performance metrics for each vehicle setup x; J_{subjective,i} represents vector of obtained by collecting or concatenating a number of i predicted subjective feedback for each vehicle setup x; w_{objective,i} represents a vector of pre-selected (e.g., user-user defined) weights for objective performance metrics indexed by i; and w_{subjective,j} represents a vector of pre-selected weights for predicted subjective feedback indexed by j, which may be the same or different weights than w_{objective,i};. Vehicle setup selection engine 434 may operate to, for example, optimize a weighted sum of the objective performance metrics and the predicted subjective feedback 432, for example, by driving Eq. 1 to optimize the total objective function J_{optimized}. For example, depending on the sign convention for the weights, vehicle setup selection engine 434 may operate to drive Eq. 1 to minimize J_{optimized} or maximize J_{optimized}. Vehicle setup selection engine 434 may select values for the vehicle setup x that optimizes J_{optimized}, and the values for weights that optimizes J_{optimized} represents an optimal vehicle setup that maximizes both the objective performance metrics and the subjective feedback.

In some embodiments, upper and lower confidence bounds may be utilized for iteratively searching through sequential optimization. For example, an upper and lower bound may be set on the value of J_{optimized} for an initial search of a vehicle state x. During the iterative optimization of J_{optimized} for a given vehicle state x, the upper and lower bounds can be updated, reducing the uncertainty in the optimization for the vehicle state.

Accordingly, vehicle setup selection engine 434 can be configured to generate explanations on why a given vehicle setup is preferential over other vehicle setups. For example, as explained above, vehicle setup selection engine 434 can receive the evaluation scores on a vehicle state basis for each vehicle setup, which can be used to generate a report for each vehicle setup that details the predicted subjective feedback. That is, similar to the questionnaire used in training, a report may be provided for each vehicle setup that gives a predicted driver opinion of the vehicle setup for various vehicle states. Further, in some implementations, the impact of each vehicle operating parameter of a respective vehicle state on the opinion can be provided as a sensitivity measure. Thus, impacts on each parameter can be reviewed and considered in selecting a vehicle setup. In another case, identification of how to tune a vehicle setup can be facilitated through by the sensitivity measures. Further still, in some implementation, an optimal vehicle setup can be provided through the balancing of objective performance metrics and predicted subjective feedback 432, as described above.

One or more of the above information provided by vehicle setup selection engine 434 can be displayed on GUI 436 for an end-user's consumption. For example, GUI 436 can provide a plurality of vehicle setups, each displayed with evaluation scores and vehicle states for understanding predicted subjective opinions on each vehicle setup. The impact of each vehicle operating parameter on the predicted opinion of each vehicle setup can also be displayed for review by an end user. One or more vehicle setups may be flagged as optimal setups according to the balancing of the subjective feedback against the objective performance metrics for ease of recognition.

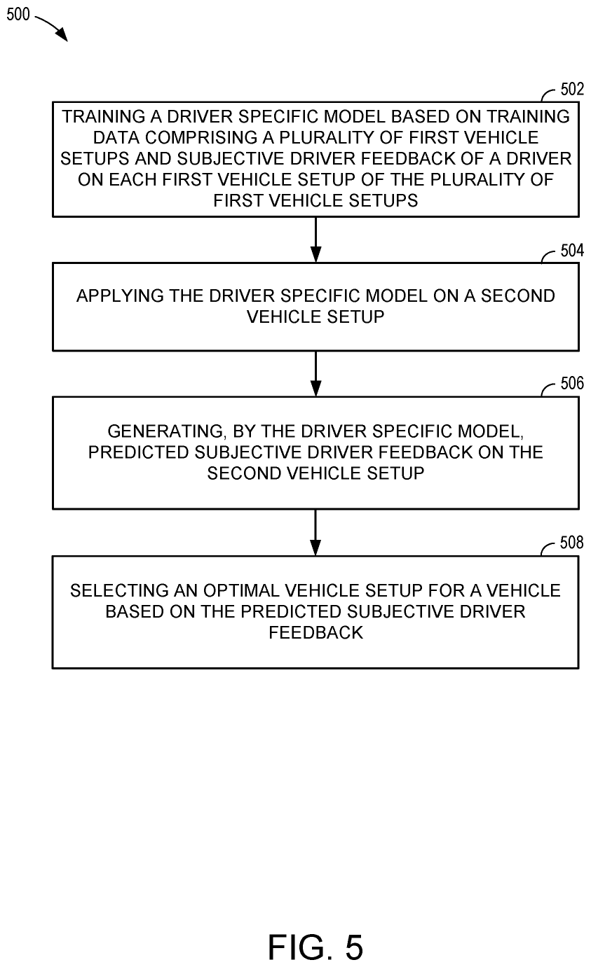

FIG. 5 is a flowchart 500 illustrating example operations that can be performed to optimize a vehicle setup in accordance with embodiments disclosed herein. In some embodiments, these operations may be performed by vehicle setup selection system 400 and/or front-end system 310 and/or back-end system 330 of FIG. 3.

At operation 502, a driver specific model is trained based on based on training data. The training data comprises a plurality of first vehicle setups and subjective driver feedback representative of a driver on each first vehicle setup of the plurality of first vehicle setups. At operation 504, the driver specific model is applied to a second vehicle setup (e.g., a candidate vehicle setup as described above). At operation 506, the driver specific model generates predicted subjective driver feedback on the second vehicle setup. At operation 508, an optimal vehicle setup is selected for a vehicle based on the predicted subjective feedback.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up vehicle setup system 200 of FIG. 2; back-end system 330 and/or front-end system 310 of FIG. 3; and vehicle setup selection system 400 of FIG. 4. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. In some examples, main memory 608 may be used for storing instructions for executing operations of flowchart 500. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for optimizing a vehicle setup, the method comprising:
training a driver specific model based on training data comprising a plurality of first vehicle setups and subjective driver feedback of a driver on each first vehicle setup of the plurality of first vehicle setups;
applying the driver specific model on a second vehicle setup;
generating, by the driver specific model, predicted subjective driver feedback on the second vehicle setup, wherein the predicted subjective driver feedback is predictive of an opinion of the driver on the second vehicle setup; and
selecting an optimal vehicle setup for a vehicle based on the predicted subjective driver feedback.

2. The method of claim 1, wherein the vehicle is a race car.

3. The method of claim 1, further comprising:
building the training data for the driver from first vehicle setup information and subjective driver feedback information provided by the driver.

4. The method of claim 1, wherein each first vehicle setup of the plurality of first vehicle setups comprises one or more vehicle operating parameters defining the vehicle setup, the vehicle parameters comprising mechanical and electrical settings of vehicle components.

5. The method of claim 1, wherein the first subjective driver feedback comprises evaluation scores assigned by the driver to vehicle states.

6. The method of claim 1, wherein the training data comprises time series data obtained from sensors on the vehicle.

7. The method of claim 1, wherein the second subjective driver feedback comprises a prediction of an evaluation scores for the second vehicle setup.

8. The method of claim 1, further comprising:
receiving, from one or more of computer simulation and real-world driving, objective performance metrics of vehicle performance for the second vehicle setup; and
providing the optimal vehicle setup based on the second subjective driver feedback and the objective performance metrics.

9. A system for optimizing a vehicle setup, comprising:
a memory storing instructions; and
one or more processors communicably coupled to the memory and configured to execute the instructions to:
train a driver specific model based on training data comprising a plurality of first vehicle setups and subjective driver feedback of a driver on each first vehicle setup of the plurality of first vehicle setups;
apply the driver specific model on a second vehicle setup;
generate, by the driver specific model, predicted subjective driver feedback on the second vehicle setup, wherein the predicted subjective driver feedback is predictive of an opinion of the driver on the second vehicle setup; and
select an optimal vehicle setup for a vehicle based on the predicted subjective driver feedback.

10. The system of claim 9, wherein the vehicle is a race car.

11. The system of claim 9, wherein the one or more processors are further configured to execute the instructions to:
building the training data for the driver from first vehicle setup information and subjective driver feedback information provided by the driver.

12. The system of claim 9, wherein each first vehicle setup of the plurality of first vehicle setups comprises one or more vehicle operating parameters defining the vehicle setup, the vehicle parameters comprising mechanical and electrical settings of vehicle components.

13. The system of claim 9, wherein the first subjective driver feedback comprises evaluation scores assigned by the driver to vehicle states.

14. The system of claim 9, wherein the training data comprises time series data obtained from sensors on the vehicle.

15. The system of claim 9, wherein the second subjective driver feedback comprises a prediction of an evaluation scores for the second vehicle setup.

16. The system of claim 9, wherein the one or more processors are further configured to execute the instructions to:
receiving, from one or more of computer simulation and real-world driving, objective performance metrics of vehicle performance for the second vehicle setup; and
providing the optimal vehicle setup based on the second subjective driver feedback and the objective performance metrics.

17. A vehicle setup selection system, the vehicle setup selection system comprising:
at least one memory configured to store instructions; and
one or more processors communicably coupled to the at least one memory and configured to execute the instruction to:
obtain candidate vehicle setup information comprising data on a plurality of candidate vehicle setups for configuring a race vehicle;
generate subjective driver feedback for each of the plurality of candidate vehicle setups by applying the candidate vehicle setup information to a driver specific machine learning model trained on subjective data of a particular driver, wherein the generated subjective driver feedback is a prediction of a subjective opinion by the particular driver on each of the plurality of candidate vehicle setups; and
provide a visualization of the plurality of candidate vehicle setups, the visualization comprising a graphical user interface (GUI) that displays each candidate vehicle setup and the subjective driver feedback for each candidate vehicle setup.

18. The vehicle setup selection system of claim 11, wherein each candidate vehicle setup is defined by a set of vehicle operating parameters comprising mechanical and electrical settings of vehicle components.

19. The vehicle setup selection system of claim 18, wherein the one or more processors are further configured to execute the instructions to:
for each candidate vehicle setup:
calculate a sensitivity measure for each vehicle operating parameter on the subjective driver feedback corresponding to a respective candidate vehicle setup,
display each sensitivity measure along with each vehicle operating parameter in association with the subjective driver feedback for the respective candidate vehicle setup.

20. The vehicle setup selection system of claim 11, wherein the one or more processors are further configured to execute the instructions to:
obtain one or more performance metrics; and
for each candidate vehicle setup, executing a optimization function on the one or more performance metrics and the subjective driver feedback corresponding to a respective candidate vehicle setup;
identify a candidate vehicle setup as an optimal vehicle setup based on driving the optimization function for each candidate vehicle setup to zero; and
displaying the optimal vehicle setup on the GUI.
